(19) United States
(12) Patent Application Publication
(10) Pub. No.: US 2007/0206999 A1
(43) Pub. Date: Sep. 6, 2007

(54) COLLAPSIBLE FLAT RACK

(76) Inventor: Martin Clive-Smith, Leek Wootton (GB)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/746,780

(22) Filed: May 10, 2007

Related U.S. Application Data
(62) Division of application No. 10/533,987, filed on May 4, 2005.

(30) Foreign Application Priority Data
Nov. 5, 2003 (GB) PCT/GB03/04805
Nov. 7, 2002 (GB) GB0226012.3

(51) Int. Cl. B60P 3/08

(52) U.S. Cl. 410/24

(57) ABSTRACT

A collapsible dual deck platform deck or flat rack container, adapted for vehicle cargo, has dual (40 fit and 45 ft) span capture and handling fittings upon twin or joint adjustable height corner support post modules, foldable transversely inward to overlie one another at platform deck ends, with an underlying hinged end gate upon one post; post modules feature telescopic rams with a pulley traveller carrying a cable lift to a movable deck.

### CROSS-REFERENCE TO RELATED APPLICATIONS

This application is a divisional of U.S. patent application Ser. No. 10/533,987 filed May 4, 2005 entitled: “Collapsible Flat Rack”. This application also claims domestic priority from PCT Application Number PCT/GB03/04805, which claims priority from United Kingdom Patent Application Number 0226012.3 all fully incorporated herein by reference.

### BACKGROUND OF THE INVENTION

Collapsible Flat Rack Collapsible platform deck, or so-called ‘flat rack’, containers adapted for carrying (road) vehicles, in particular cars, are known.

Typically the flat rack is some 40 ft long, with a deck capacity for 2 or 3 cars in tandem.

Recent developments in containers have allowed an increase in standardised length from 40 ft to 45 ft—and in some countries even longer at 58 ft.

Handling devices and transport vehicles for the former 40 ft standard containers have hitherto been adapted to carry only 40 ft lengths.

Nowadays, longer 45 ft length spreaders for top lifting and 45 ft span cargo hold cell guides are increasingly common in containerised sea going cargo vessels or ships, for constraining and guiding 45 ft containers.

For compatibility between 40 ft and 45 ft containers, supplementary capture and handling points, (such as twistlocks upon corner posts), are required at 40 ft positions on 45 ft long containers.

This allows 40 ft spreaders, and perhaps 40 ft trailers or rail wagons, to engage capture fittings at 40 ft positions, even though the container extends each end by another 2 ft.

However, a problem arises in using 40 ft spreaders to handle 45 ft containers within 45 ft span cell guides.

Once within a ship, a 45 ft container slides down 45 ft span cell guides, rubbing its corner fittings upon cell guide surfaces.

In this way a 45 ft container can be lowered safely and rapidly down into a vessel in accurate registration with—and to sit with its handling and support fittings upon—those of an underlying 45 ft container.

For so long as a 40 ft span spreader remains attached to a 45 ft container, accuracy of lateral and longitudinal location is ensured within cell guides.

Once detached from a container, a 40 ft spreader can be raised up a cell guide, albeit is no longer governed by cell guide to container contact.

However, the spreader is moving away from exposed cargo on the deck of the container just deposited.

For container pick up, a crane must negotiate the spreader carefully down between cell guides and accurately register respective 40 ft capture fittings.

In doing so, the spreader and cargo can come into inadvertent contact, with attendant damage risk.

This is less of a concern for solid roof (eg dry freight) containers, since if capture fittings should fail to register and engage, the roof deflects and supports the spreader and protects the cargo inside.

An open frame flat rack has no roof, so a 40 ft spreader traveling down between cell guides and missing top corner fittings can easily impact exposed cargo.

Some form of cargo protection is thus desirable for a flat rack.

One protection option would be to insist that 45 ft spreaders be used in cell guide operation, and indeed this is virtually the norm.

A 45 ft spreader could readily pass down cell guides and locate directly into 45 ft capture fittings, such as those located upon corner posts—and safely pick up the flat rack without cargo damage.

However, 40 ft spreaders are still in use—even on 45 ft cell guide vessels.

For compatibility with existing container fleets, capture and handling fittings at 40 ft positions must be provided—as land based operations (where there are no cell guides) still use 40 ft spreaders.

Statement (s) of Invention According to one aspect of the invention, a flat rack has capture and handling fittings, such as upon corner posts, at different handling spans.

A prime example would be capture and handling fittings at both 45 ft and 40 ft standard positions.

This allows dual mode handling operation.

Capture and handling fittings could be upon respective support posts or share a post.

Multiple posts could be grouped in post modules with common extension drives, such as hydraulic rams and/or cables.

Flat Rack Collapse Fold Flat racks are generally collapsible, so that when cargo is unloaded from a platform base, end frames and corner posts can be folded down thereupon, in a collapsed compact ‘flat-pack’ (return-empty) configuration.

Such collapsed units can be stacked, one upon another, for economical storage and transport.

The container stack shares the footprint of an individual container and stack depth can be contrived to match container depth standards.

Thus, when coupled together (say through their respective capture fittings), the stack contents can be handled together as a unified load.

If corner posts are required at 40 ft and 45 ft positions a total of 8 corner posts surmount a common platform deck and all of which be folded down—perhaps one on top of the other—adding to folded stack height.

According to another aspect of the invention, a flat rack has handling capture fittings upon corner posts, at different capture and handling spans, such as at both 40 ft and 45 ft standard positions, all configured for compact collapse fold upon a base deck, or inter-nested multiple deck platforms.

In a particular construction, a flat rack has at one or both ends of a rectangular base a multiple (two or more) post structure, each with respective capture and handling fittings at is upper end, for multiple alternative container handling spans.

Support posts at opposite sides could be pivot mounted for inward transverse fold, to overlie one another upon a platform deck.

Support post pivots at different heights, would allow mutual collapse fold overlay.

Support post pivot mountings could be biased by torsion bar springs, to counterbalance post weight.

On-board hydraulic rams, and cable pulley drive coupling, could effect support post extension and suspended deck movement.

Paired telescopic support posts, could be operable by joint ram and cable drive, with respective capture and handling fittings at different standard spans A movable deck, could be carried at or adjacent each corner, by paired adjustable span support posts, with respective capture and handling fittings at different spans.

A movable upper deck could be carried by support posts surmounting a base deck.

An end access closure gate could be fitted between paired support posts, with respective capture and handling fittings at opposite sides of each deck end.

A tapered deck end profile could create end ramps for a vehicle cargo, to allow vehicle tilt for compact fit within flat rack deck confines.

Similarly, a hinged trap door in a deck floor intermediate deck ends could allow local tilt of a vehicle cargo disposed with wheels thereupon.

Multiple capture and handling fittings could be carried by individual support posts.

A support post extension ram could be disposed within post confines.

Similarly, a cable suspension could be disposed within support post confines.

Dual inter-fitting decks could be carried between adjustable span support posts, pivotally mounted for inward transverse fold, to allow a compact overall collapse fold with support posts within mutually inset decks.

A selectively operable deck lock could secure deck position.

A selectively operable collapse fold interlock could be fitted between inward folded support posts, gate carried thereby, and underlying deck.

A collapse fold support post and underlying deck interaction could brace residual corner stub posts and attendant capture and handling fittings.

A movable deck over-travel facility, could facilitate under deck loading.

A movable deck over-travel lock could secure under deck loading access.

Embodiment(s) There now follows a description of some particular embodiments of the invention, by way of example only, with reference to the accompanying diagrammatic and schematic drawings.

Mix and Match Various features identified can be mixed and matched 'selectively—albeit it is impractical here to set out every feasible combination.

### BRIEF DESCRIPTION OF THE DRAWINGS

These and other features and advantages of the present invention will be better understood by reading the following detailed description, taken together with the drawings wherein:

FIG. 1 shows a side elevation of a known single (base) platform deck or flat rack of some 40 ft span, with triple tandem vehicle (car) load;

FIG. 2 shows an extended variant of the flat rack of FIG. 1 extended to some 45 ft span, for location in a containerised cargo vessel cell guides, along with a spreader beam of 40 ft span;

FIG. 3 shows a perspective view of a collapsible multiple (dual) deck flat rack adapted for vehicle load according to the invention and with both 40 ft and 45 ft capture and handling fittings;

FIGS. 4A through 4C show sequential loading operation for the dual deck flat rack of FIG. 3; More specifically: FIG. 4A shows a movable upper deck lowered upon a base deck between erect corner support post modules; FIG. 4B shows initial car cargo loading of the lowered upper deck;

FIG. 4C shows elevation of the upper deck to allow base deck loading and optional support post extension to present capture and handling fittings above upper deck load height;

FIG. 5 shows a fully loaded flat rack of FIG. 4C with end support post modules extended to support an overlying container;

FIGS. 6 and 7 show an end elevations of the flat rack of FIGS. 3,4 and 5, with a single full-width end gate hung from one corner post closed; double half-span gates hung from respective posts may be substituted; More specifically: FIG. 6 shows a single gate swung open for unobstructed deck end access; FIG. 7 shows gate closed and coupled between opposite end posts as end bracing;

FIG. 8 shows an end elevation of transverse inward (mutually overlaid) fold of dual (40 ft and 45 ft) span corner support post modules at one deck end;

FIG. 9 shows an end elevation a stack of collapsed flat racks of FIGS. 3,4 and 5;

FIG. 10 shows a detail of a dual (40 fit and 45 ft) span corner end post module, with hydraulic ram and cable pulley lift, for the flat rack of FIGS. 3,4 and 5;

FIGS. 11 through 14 show views of an engineered flat rack embodying features of preceding drawings;

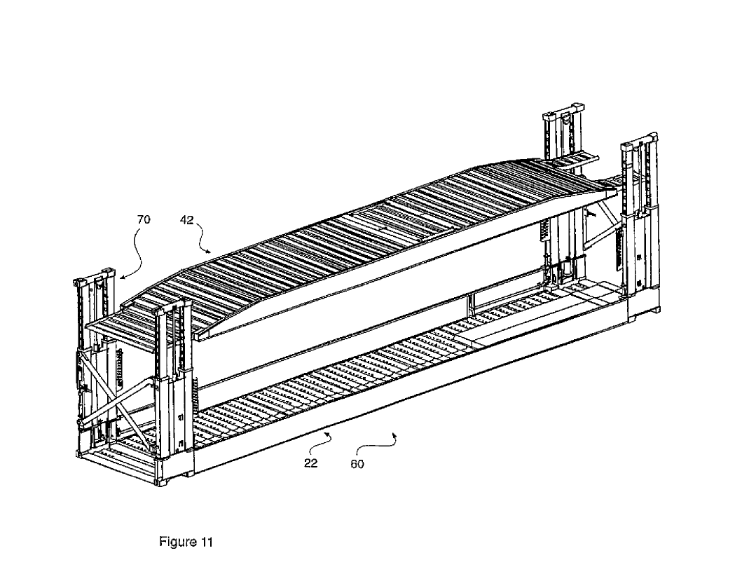

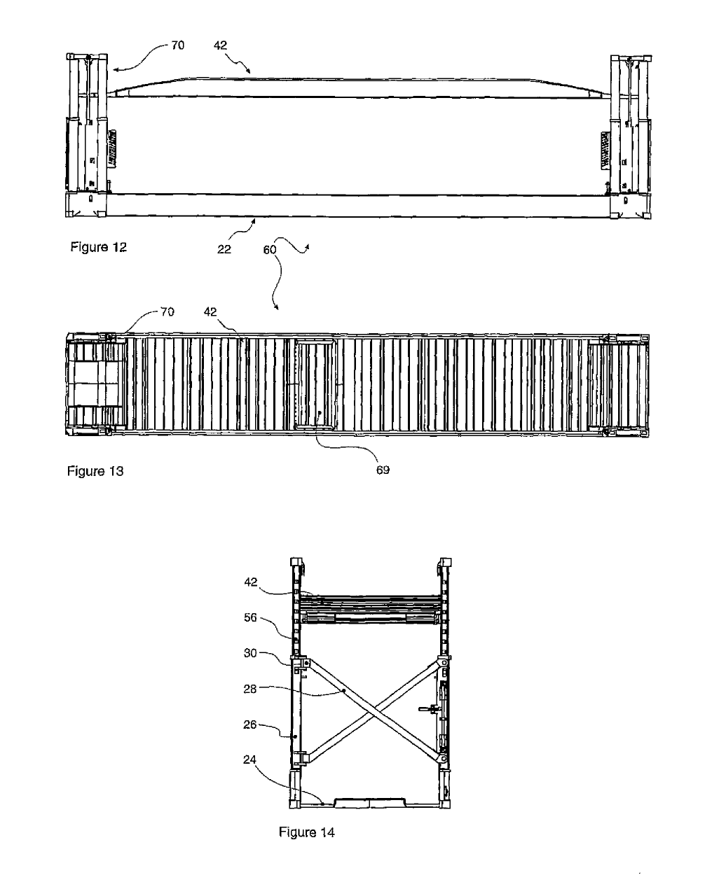

More specifically: FIG. 11 shows a 3D perspective view of a dual deck flat rack, with movable upper deck carried by corner support post modules (with 40 ft and 45 ft span capture and handling fittings), surmounting a base deck and mounted for inward compact collapse fold; FIG. 12 shows a side elevation of the flat rack of FIG. 11, with upper deck elevated from a cable suspension with pulley traveler upon extendible rams in corner post modules; FIG. 13 shows a plan view of the flat rack of FIGS. 11 and 12; and FIG. 14 shows an end elevation of the flat rack of FIGS. 11 through 13, with single hinged end gate addressing both upper and base deck access.

### DETAILED DESCRIPTION OF THE PREFERRED EMBODIMENTS

FIG. 1 depicts a typical known collapsible container 50 of some 40 ft length or span, with a platform base deck 10 surmounted at each end by a pair of opposed corner posts 12.

Upon each corner post 12 is a top capture and handling fitting 13, such as a hollow rectangular box with apertures on three outermost sides for a standard so-called ‘twistlock’.

Similarly, a bottom capture and handling fitting 15 is located at each four bottom corners of flat rack 50.

FIG. 1 depicts three small cars 16 disposed in tandem upon base deck platform 10 of flat rack 50.

Overall flat rack 50 height (distance of top fitting 13 above ground) is limited by fixed end support post frames 46.

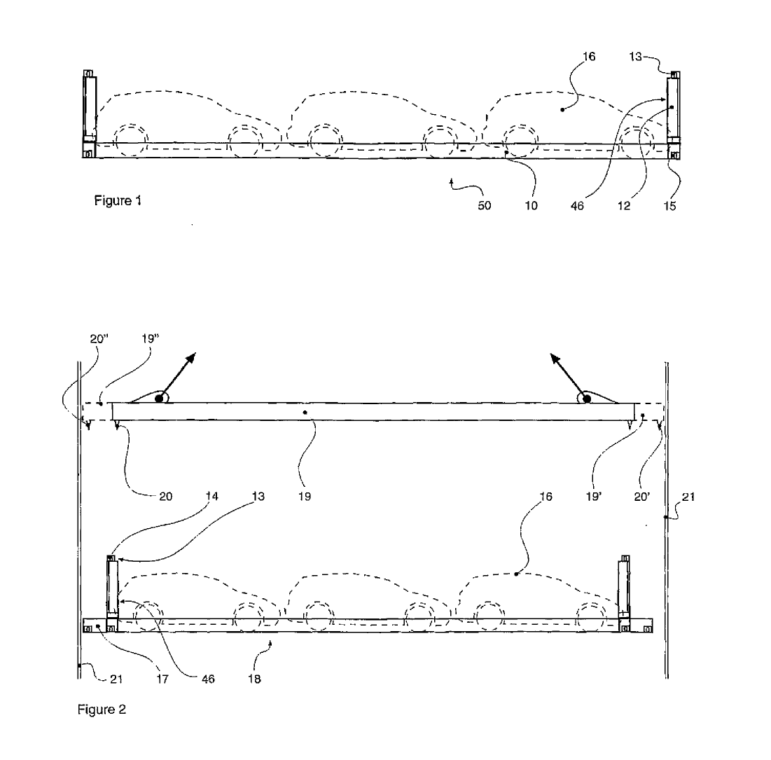

FIG. 2 depicts a flat rack 18 similar to flat rack 50, but with base deck stub extensions 17 at each end—taking overall length typically to some 45 ft or more.

However, support posts 46 remain at a 40 ft span.

Suspended above flat rack 18 is a crane lift spreader 19 with capture and handling fittings (such as twistlocks) 20—to engage top apertures 14 of top fittings 13 for capture and lift of flat rack 18.

Should a capture fitting 20 not line up with top aperture 14 of top fitting 13, but sit over to one side, as denotedby 19′ and with capture fitting at 20′, serious contact damage could occur to car 16 roof.

When a 45 ft span flat rack 18 is located in corresponding 45 ft span vessel cell guides 21, its lateral and longitudinal position is constrained.

However, a 40 ft span spreader 19 lowered down inside 45 ft span cell guides 21, can still swing from one side to the other, as denoted by broken line 19′, and cause damage to a car 16.

If spreader 19 were made, say, 45 ft span, as denoted by broken line 19″, and with twistlocks located at 20′, 20″, no cargo 16 damage could arise, as spreader 19″ would also be constrained by cell guides 21.

Hitherto, neither spreaders nor containers have featured both 40 ft and 45 ft span capture fittings 20.

Thus cargo 16 of flat rack 18 is protected from 45 ft spreader 19 contact, but not from a 40 ft spreader 19.

FIG. 3 shows a perspective view of an embodiment of the present invention, with multiple decks and dual (40 ft and 45 ft) span capture and handling fittings upon respective paired support posts, configured as collapse fold corner modules 70.

More specifically, a base 22 is configured as a shallow tray of longitudinal upstanding side rails 23 at each side of an intervening braced platform deck floor 24 of corrugated sheet steel.

Inboard (bottom) support posts 25 are located at a 40 ft span position and adjacent outboard (bottom) posts 26 at a 45 ft span position.

Bottom posts 25 and 26 are joined structurally by bridge plates 47, to create an integrated corner post module 70 surmounting base 22.

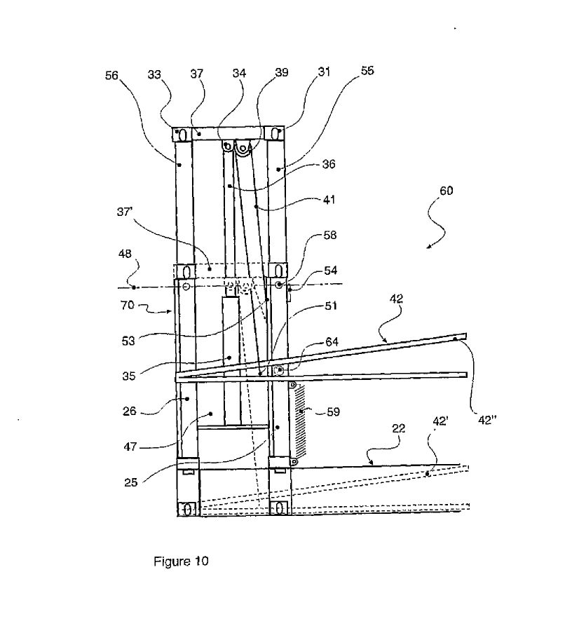

Bottom posts 25 and 26 are pivotally mounted upon base 22 by hinges 29 fitted to side rails 23, along with paired torsion bar bias springs **, as detailed in FIGS. 8 and 10.

Bottom posts 25,26 are configured as hollow (rectangular or circular) box sections, from which telescope respective inboard and outboard upper posts 55,56 to carry a movable upper deck 42.

Upper posts 55,56 are capped by respective capture and handling top fittings 31,33.

A top rail 37 joins fittings 31,33 and is extended inward by a (spreader impact) guard bar 38.

Paired (or single) end access gates 28 are mounted by hinges 39 upon outboard bottom posts 26 at opposite deck ends.

Hinges 30 allow gates 28 to rotate through 270 degrees, from a closed position abutting one another or an opposite post 26, to a folded back open position (not illustrated) alongside base 22.

Above base deck 24 is a movable upper deck 42 of upstanding longitudinal side rails 49 at opposed sides of braced platform deck floor 43, also of corrugated sheet steel.

Upper deck 42 is suspended from wire cable or chains 41 detachably connected by removable pins 51 to side rails 49—cable 41 passing over pulley wheels 39 mounted upon inboard upper posts 55.

Pulleys 39 are disposed close to post 55 and top fitting 31 axis, to bring cable 41 close to, or within the confines of, corner support post module 70.

As more readily discerned from FIG. 10, the other end of cable 41 is secured to inboard bottom post 25 at anchor pin 53.

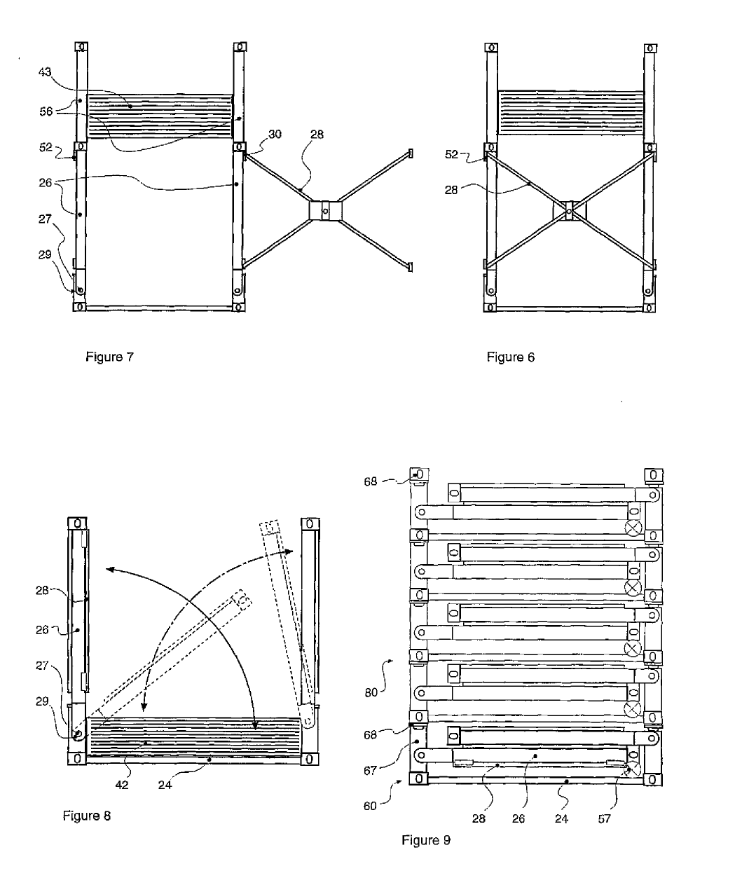

A travel limit stop 54 is fitted to one or both bottom posts 25,26, for upper deck 42 support when cables 41 are released to allow upper post 55,56 extension to present capture fittings 31,33 above an upper deck load 26, as depicted in FIG. 6.

Limit stop 54 represents a lower limit for upper deck 42 when cargo is carried upon base deck 22, but is disengaged to allow upper deck 42 to be lowered upon base deck 22 in a single deck operating mode or preparatory to overall flat rack collapse.

A removable detent 58 is operable to lock together associated bottom and upper posts 25/55,26/56.

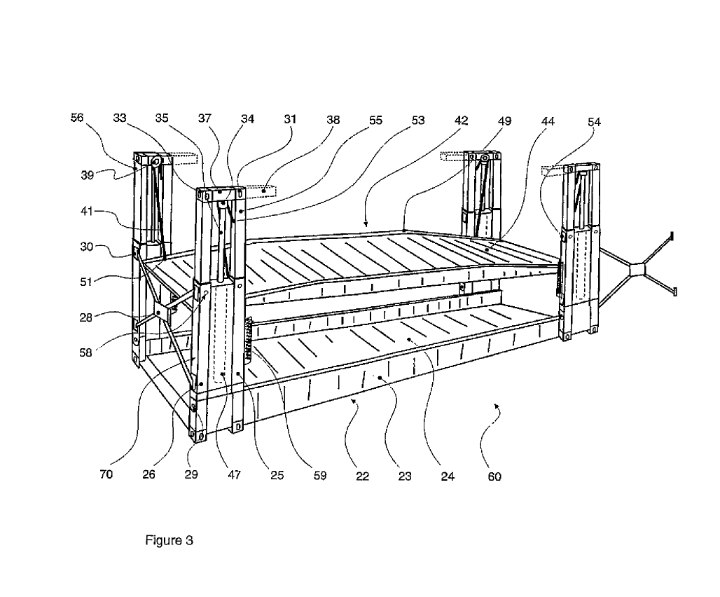

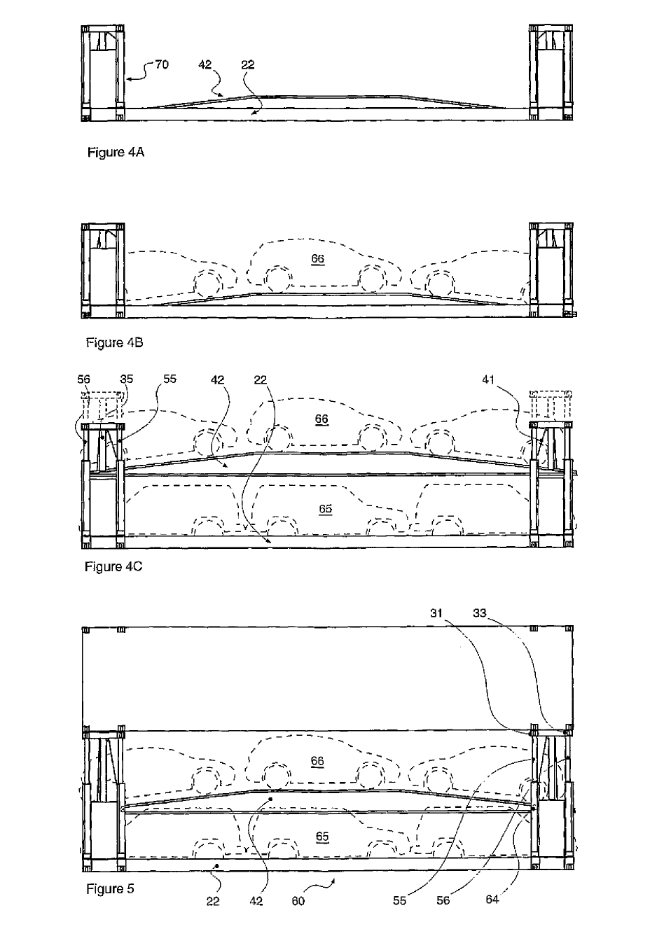

FIGS. 4 and 5 show upper support post 55,56 extension, initially to carry upper deck 42 and then beyond an upper deck load 66.

Operational, absent any transverse header beams or braces, upper deck 42, along with its car load 66, can be carried way above base deck 22.

This provides ample drive-on/off headroom for a base deck car load 65.

Once both decks 22,42 are loaded, upper deck 42 can be lowered closer to base deck 22, as depicted in FIG. 5.

In this mode, the roofs of tall vehicles 65 on base deck 22 can intrude somewhat into the under-deck confines of upper deck 42, allowing a closely inter-nested compact load profile.

Upper deck 42 can be restrained by locks 64, with and cables 41 uncoupled by releasing pins 51.

This allows full upper post 55,56 extension, to present associated capture fittings 31,33 above upper deck car load 66.

In this mode container 60 can be handled by a spreader (not shown) or support a corresponding container stacked upon it.

Inter-Post Detents For security, inter-post detents 58 are engaged between upper posts 55,56 and respective bottom posts 25,26, as a default load carrying stop, upon failure of support wire 41 or lift ram 35 collapse.

Once raised to a desired position, upper support posts 55,56 are locked to respective bottom posts 25,26 by detents 58, shot through corresponding aligned holes therein.

Detents 58 take lifting, racking and stacking loads placed upon capture fittings 31 or 33.

Inter-post detents 58 are desirably configured as flat-faced latch pins, for load spread and to minimize wear or risk of seizure in situ.

Lift Rams Hydraulic lift rams 35 are located between inboard and outboard bottom support posts 25,26.

Extendible ram pistons 36 lie between upper inboard and outboard support posts 55,56 and are secured to bar 37 by a capture pin 34.

Lift rams 35 sit upon a base frame 45 within corner module 70 and operate selectively—say through a hand pump—upon bar 37 through capture pin 34 Ram 36 retraction or extension moves upper posts 55,56 and associated pulley 39, which effectively lengthens or shortens the run of cable 41 by double the ram 36 ‘throw’ for rapid deck movement.

U-Shape Deck Profile Upper and base decks 42,22 are of complementary ‘U’-shaped cross-sectional profile for a certain inter-fit.

Thus, when fully lowered by cables 41 and retraction of lift rams 35, upper deck 42 can sit or nest within ‘U’ tray profile confines of base deck 22—as depicted in broken line in the fragmentary end view of FIG. 10.

Guard bar 38 inhibits contact of, say, a laterally mis-aligned 40 ft spreader with upper deck load 66.

Thus either a 40 ft or 45 spreader can be used without risk of load damage—unlike, say, the flat rack 18 of FIG. 2.

Post Hinge

A post hinge 29 has a pivot pin 27 axis of horizontal longitudinal orientation, so bottom posts 25 and 26 can fold transversely together towards base deck 24.

FIG. 6 shows differential relative height of hinges 29 for bottom posts 25,26 at opposite deck sides.

This allows collapsed posts 25,26 mutually to overlie one another and sit within the base deck 22 confines when folded transversely inward.

Gate Lock In order to keep support posts 25,26 erect under transport and handling loads, single or multiple end gates 28 are locked together and/or to an opposite post by a spigot 52.

When post and gate are fully collapse folded inward, they are secured to an underlying base deck 24 by a lock 57—creating a stiff braced structure.

Stub Posts Residual upstanding stub posts 67, with respective top capture and handling fittings 68, protrude beyond the transverse inward folded support posts 25,26.

This allows mutual stacking—as represented in FIG. 9—without contact damage to internal fittings.

These stub posts 67 are subjected to severe racking and stacking loads and are braced by the interlocked post, gate and deck structure.

FIG. 7 depicts end gate (s) 28 swung open through 180 degrees, allowing end access for cargo onto floor 24 of base 22.

Deck floor 44 of upper deck 42 is shown in a raised position, allowing a car 65 to drive in and out underneath any cars 66 upon floor 23.

FIG. 8 shows a corresponding end elevation to FIGS. 6 and 7, but with upper corner support post extensions 55,56 retracted into respective bottom corner support posts 25,26.

End gate 28 is folded back through 270 to lie alongside longitudinal sides of flat rack 60.

Upper deck 42 has been lowered and its floor surface 44 lies upon base deck floor 24.

In order to collapse flat rack 22, posts 25 and 26 are counter folded inward—respectively from left and then from the right as viewed—as indicated by arrows A and B towards floor 24 about pivot pins 27.

Guard bar 38 and top rail 37 can fold easily with the corner posts 25, 26 and one or more end gates 28 can fold along therewith to lie unobtrusively within a compact overall collapse folded module 60 profile.

A bottom support post for a single end gate 28 is folded first, so gate 28 sits underneath both its appended post and an overlying post.

A ramp end profile base deck 24 allows bottom post 25, 25 fold within the depth of base side rails 23.

Integrated Support Posts It is envisaged that discrete posts 25/55,26/56 might be integrated as a single post.

Capture fittings 31,33 for 45 ft and 40 ft span could be (re-) located along top rail 37 or guard bar 38.

Stack FIG. 8 is an end elevation of a stack 80 of some five flat-pack collapsed flat racks 60, with respective support posts 25 and 26 folded inward as described.

Overall stack 80 depth generally equates to that of an erected individual flat rack 60, with top posts 55,56 retracted within respective bottom posts 25,26.

Flat racks 60 can be inter-coupled through respective adjoining capture fittings 68 to create a unitary stack assembly 80, which can be handled from uppermost top fittings 68.

FIG. 10 is an enlarged fragmentary side elevation detail of a corner support post module at one end of flat rack 60.

Corner posts 25,26 are erected and locked in place with one or more end gates 28 locked together, or to opposite posts from which they are hinged.

Posts 55,56 are raised, along with top rail 37, capture fittings 31,33 and guard rail 38 from a fully retracted position shown in broken line 37′.

Pump driven hydraulic ram 35 moves posts 55,56 up and down within posts 25,26.

A ram piston rod 36 acts through a pin 34 upon top rail 37 to push up top rail 37 and raise upper structure 60 (of elements 55,56, 37 and 38).

Once raised to a desired height, posts 55,56 can be locked in place by detent 58 operative on axis 48.

For retraction of upper support posts 55,56, detent 58 is withdrawn so gravity action retracts ram piston 36, and/or by exhaust pumping of ram 35 cylinder.

Raising and lowering of upper support posts 55,56 has an additional function.

A pulley wheel 39 is mounted upon bar 37 by a bracket 49.

Over the pulley 39 is draped a chain or wire rope 41, pinned at one end ** to upper deck 42, and at the other end is secured to post 25 by a pin 63.

As upper support posts 55,56 are raised up and down by ram 35, so wire 41 transfers the motion to upper deck 42, from a lowermost position 42′ nested within base 22 up to a desired height 42″.

Once at desired height, deck 42 can be pinned in place by a deck lock 64 upon post 25—and upon which deck 42 can rest solidly for transport.

Although the flat rack 60 described has telescopic corner support posts 55,56, fixed height corner support posts are also envisaged.

Other embodiments might include a profiled deck 24 surface to maximise slope of cars 66 placed upon it.

In this case, movable upper deck 42 has a platform infill at the top edge of side rails 43—affording greater headspace to an underlying cargo on base deck 22.

As depicted in FIG. 5, upper deck floor 24 might be replaced, partially or overall, by spaced transverse bars 61, locally to capture and support individual car 66 wheels.

Rather than being fixed to deck 22, bars 61 might be adjustable, to allow selective local tilt of cars 66 when upper deck 42 is raised clear of base 22.

Built-in rams 35 or pulley wheels 39 and cables or chains 41 are not essential.

Rather, upper deck 42 could be raised and lowered by external or auxiliary means—such as a crane, fork truck or some other specially adapted device.

Base deck 22 and indeed also movable upper deck 42 could be of adjustable (eg telescopic) span.

Thus, say, a 45 ft flat rack could be extended or retracted to some other length.

Whilst 40 ft and 45 ft lengths are widely adopted standards, others can be accommodated.

Upper deck 42 could be raised to a high level, as a protective cover or roof over lower deck cargo.

End gate (s) 28 could be wholly or partially in filled or paneled, for cargo protection.

Side curtains could hang from guard bars 38 between posts 55, and connected to bottom side rails 23, for an enclosed cargo space.

One end of deck 42 could be raised before the other, and vehicles 26 driven up the slope—requiring less lifting work by rams 35.

Base and upper decks 22,42 can act together when nested and even locked together as an integrated structure to support larger heavier vehicles or cargo.

Vehicles wider than (erect) post 15,16 spacing can be driven between, by canting them out beyond the vertical erect position illustrated.

Indeed posts could be folded outward, say to a horizontal position, for an access width greater than the internal width of base 14.

Deck 42 can be removable.

Deck floors 24,44 can be of multiple discrete (albeit possibly edge interlinked) elements, for individual relative local slope adjustment, more readily to accommodate different car shapes and sizes.

Alternatives of deck end ramps and intermediate trap doors are discussed later.

Pulley Disposition The cable transfer pulley is desirably fitted at or close to the piston ram axis centre line.

Post Base Pivot The post base pivot is also desirably fitted at or close to the post axis or centre-line.

Taller & Tapered Vehicle Profile Taller or more upright stance vehicles, such as so-called people carriers or multi-purpose vehicles (MPV's) have a somewhat tapered profile, from a taller rear (tailgate) end to a shallower front bonnet.

Load height or head space between decks when in their transmit position is generally of even depth—and so may be inadequate for taller vehicles or inefficiently occupied by such a multiple load profile.

The Applicant's earlier Multi-Deck PCT/GB97/02319 envisaged multiple decks with relative deck portion and attendant load tilt and re-orientation, for denser inter-nesting load packing.

Deck Ramp Ends Ramp ends of a deck allow end vehicles to sit with one set of (rear) wheels somewhat lower.

This would require end vehicles to be loaded front first from respective ends, for with decks fully separated to be reversed on from one end.

Deck Trap Door Similarly, a deck trap door, (such as 69 in FIG. 13 upper deck), could be fitted—to allow wheels at a taller (rear) vehicle end to sit lower in the deck and bring the roof contour into greater conformity with available load height.

This includes vertical between deck load space.

Component List 10 platform base 12 corner posts 13 top capture+handling fitting 14 top apertures 15 bottom capture fitting 16 car cargo load 18 flat rack 19,19′ crane lift spreader 20,20′ capture fitting (spreader 19) 21 cell guides 22 base 23 longitudinal side rails 24 platform deck floor 25 (inboard) bottom support post 26 (outboard) bottom support post 27 pivot pin 28 end gate 29 post hinge 30 gate hinge 31 top capture and handling fitting 33 top capture and handling fitting 34 capture pin 35 lift ram 36 ram piston 37 bar 38 guard bar 39 pulley 41 wire cable/chain 42,42′ (movable) upper deck (+42″) 43 side rail 44 deck 45 ram frame 46 corner support post end frames 47 bridge plate 48 detent (58) axis 49 pulley bracket 50 flat rack 51 removable cable pin 52 gate spigot lock 53 cable anchor pin 54 travel limit stop 55 (inboard) upper post 56 (outboard) upper post

57 gate-post-deck lock 58 inter-post detent 59 bias springs 60 flat rack 61 deck bars 62 bar position 64 (upper) deck lock 65 (lower deck) car load 66 (upper deck) car load 67 stub post 68 capture+handling fitting 69 (deck) trap door 70 corner support post module 80 stack.

We claim:

1. A platform deck or flat rack container having a flat deck on which are disposed a plurality of pairs of capture and handling fittings disposed at multiple positions along first and second longitudinal sides of said deck, for conformity with various handling standards with respective support posts, and attendant said capture and handling fittings, at different spans with a cable suspension disposed within support post confines.

2. The platform deck or flat rack container of claim 1 wherein said capture and handling fittings are coupled to said flat deck.

3. The platform deck or flat rack container of claim 1 wherein said capture and handling fittings are foldable against said flat deck.

4. The platform deck or flat rack container of claim 1 wherein said capture and handling fittings are removably mounted to said flat deck.

5. The platform deck or flat rack container of claim 1 wherein said pairs of capture and handling fittings disposed at multiple positions along first and second longitudinal sides of said deck are disposed at first and second ends of said flat deck.

6. The platform deck or flat rack container of claim 1 wherein said pairs of capture and handling fittings disposed at multiple positions along first and second longitudinal sides of said deck are disposed inwardly from said first and second ends of said flat deck.

7. A platform deck or flat rack container having a flat deck on which are disposed a plurality of pairs of capture and handling fittings disposed at multiple positions along first and second longitudinal sides of said deck, for conformity with various handling standards, and wherein said plurality of pairs of capture and handling fittings are adjustable in capture and handling height with selectively operable collapse fold interlock, between inward folded support posts, gate carried thereby, and underlying said flat deck.

8. The platform deck or flat rack container of claim 7 wherein said capture and handling fittings are coupled to said flat deck.

9. The platform deck or flat rack container of claim 7 wherein said capture and handling fittings are foldable against said flat deck.

10. The platform deck or flat rack container of claim 7 wherein said capture and handling fittings are removably mounted to said flat deck.

11. The platform deck or flat rack container of claim 7 wherein said pairs of capture and handling fittings disposed at multiple positions along first and second longitudinal sides of said deck are disposed at first and second ends of said flat deck.

12. The platform deck or flat rack container of claim 7 wherein said pairs of capture and handling fittings disposed at multiple positions along first and second longitudinal sides of said deck are disposed inwardly from said first and second ends of said flat deck.

13. A platform deck or flat rack container having a flat deck on which are disposed a plurality of pairs of capture and handling fittings disposed at multiple positions along first and second longitudinal sides of said deck, for conformity with various handling standards with respective support posts, and attendant said capture and handling fittings, at different spans with a cable suspension disposed within support post confines, and wherein said plurality of pairs of capture and handling fittings are adjustable in capture and handling height with selectively operable collapse fold interlock, between inward folded support posts, gate carried thereby, and underlying said flat deck.

14. The platform deck or flat rack container of claim 13 wherein said capture and handling fittings are coupled to said flat deck.

15. The platform deck or flat rack container of claim 13 wherein said capture and handling fittings are foldable against said flat deck.

16. The platform deck or flat rack container of claim 13 wherein said capture and handling fittings are removably mounted to said flat deck.

17. The platform deck or flat rack container of claim 13 wherein said pairs of capture and handling fittings disposed at multiple positions along first and second longitudinal sides of said deck are disposed at first and second ends of said flat deck.

18. The platform deck or flat rack container of claim 13 wherein said pairs of capture and handling fittings disposed at multiple positions along first and second longitudinal sides of said deck are disposed inwardly from said first and second ends of said flat deck.
